(19) United States
(12) Patent Application Publication
(10) Pub. No.: US 2001/0039859 A1
(43) Pub. Date: Nov. 15, 2001

(54) UNIVERSAL WRENCH

(75) Inventor: MAX HERBERT PASBRIG, ORSELINA (CH)

Correspondence Address: MILLEN, WHITE, ZELANO & BRANIGAN, P.C., 2200 CLARENDON BLVD., SUITE 1400, ARLINGTON, VA, 22201, US

(73) Assignee: MAX-HERBERT PASBRIG

(21) Appl. No.: 09/305,286

(22) Filed: May 5, 1999

(51) Int. Cl. B25B 13/28

(52) U.S. Cl. 81/100

(57) ABSTRACT

The universal wrench consists of a handle (1) that is made of flat parts (2, 3) that are connected by pins and are provided with a coating (27) and with clamping parts (9, 10) on their ends and have offsets (2′, 3′), which form a support slot (10) for clamping body (8), as well as a clamping body (8) with clamping surfaces (13, 14, 15) and a bearing flange (23) with support slot (20) that has a varying diameter (18, 19) for swivel axis (21), which can move in recesses (17) of handle parts (2, 3) against a spring (25) and on which wrench body (8) can pivot and is mounted in an adjustable manner in the gripping opening.

The invention relates to a universal wrench according to claim 1.

Known wrenches of this type have the drawback that the wrench body is held only conditionally on the parts that are to be gripped, and it is possible to secure the wrench body in the selected position in the support slot and to make the intended change of the gripping opening and the gripping angle only to a limited extent.

The object of the invention is therefore to improve a universal wrench of the above-mentioned type in such a way that the wrench body is held against the part that is being gripped and in the selected position in the support slot, and a change of the gripping opening and the gripping angle is possible to an unlimited extent.

This object is achieved according to the invention in a universal wrench according to the introductory clause of claim 1 by the characterizing features of this claim.

Advantageous further developments of the invention are claimed in the dependent claims.

The design of the handle and the wrench body according to the invention and the arrangement of spring means make it possible to hold the wrench body against the part that is being gripped and in the selected position in the support slot and to change the gripping opening and the gripping angle.

The handle is suitably provided with a coating made of suitable material for better handling.

The universal wrench that is thus designed can be used according to the type of ratchet tool, since the wrench body is held tightly against the part that is being gripped by the arrangement of spring means. It is advantageous if the swivel axis of the wrench body has varying diameters that correspond to those of the recesses of the support slot of the wrench body and can be moved against the pressure of a spring in such a way that engaging and disengaging of the swivel axis can take place in the selected recess in the support slot of the wrench body to be able to make a change in the gripping opening and the gripping angle.

The invention will be described in more detail below based on four embodiments that are depicted schematized in the drawings. Here:

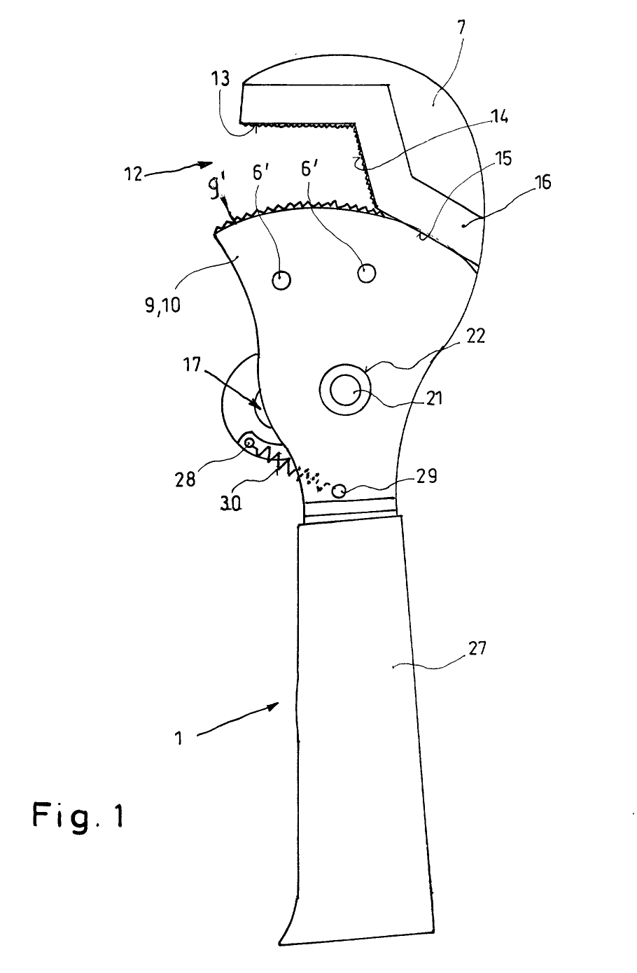

FIG. 1 shows a top view of an embodiment, and

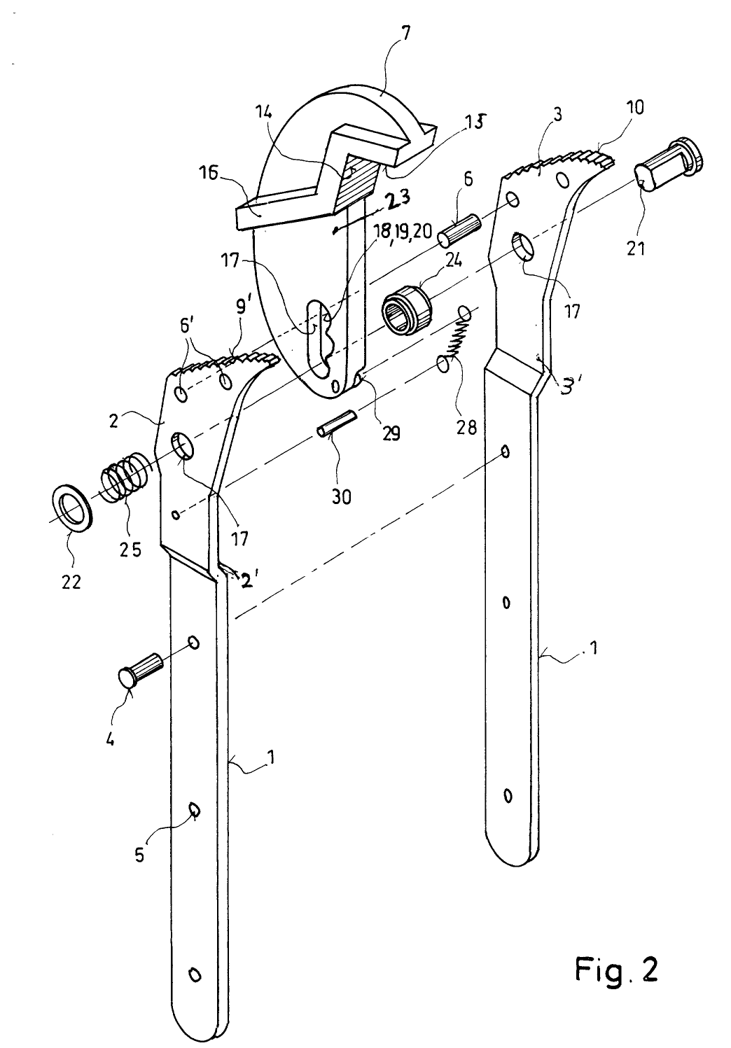

FIG. 2 shows a detailed representation of the embodiment of FIG. 1.

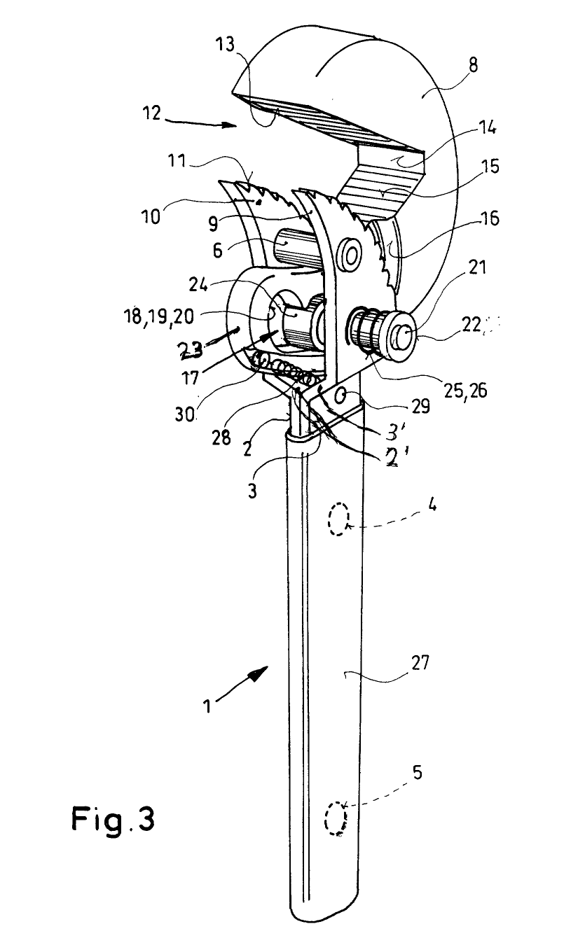

FIG. 3 shows a top view of a second embodiment.

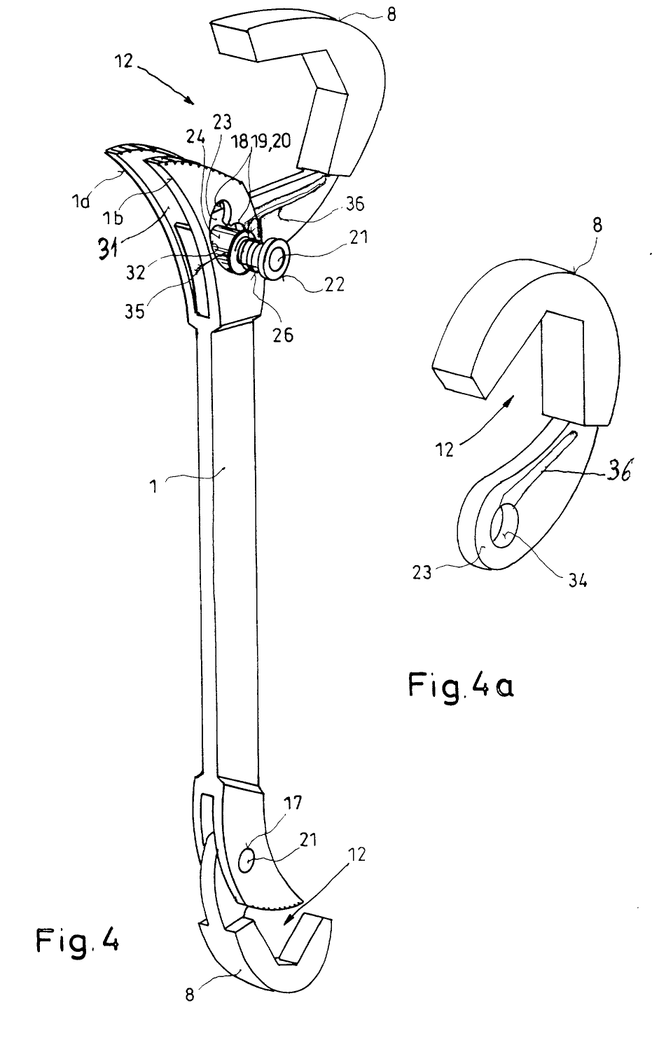

FIG. 4 shows a top view of a third embodiment.

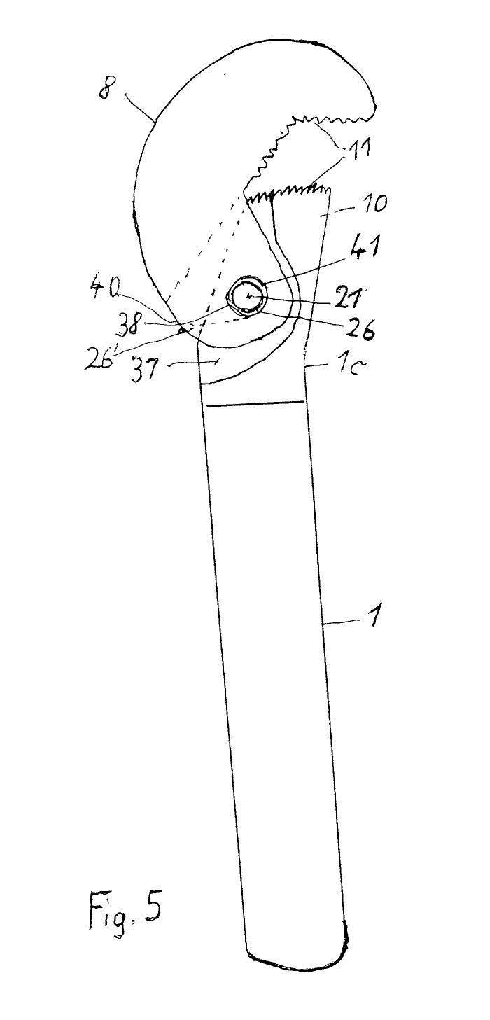

FIG. 5 shows a side view of a fourth embodiment. The depicted universal wrenches consist of a handle 1 and wrench bodies 7, 8. Handle 1, FIGS. 1, 2 and 3, consists of two flat parts 2 and 3, which are held together by tie bolts 4, 5 and 6, whereby tie bolt 6 is also designed as a stop pin for wrench body 7, 8. For better handling, handle 1 is provided with a coating 27. On their upper ends, handle parts 2, 3 are equipped with offsets 2′, 3′, which form a support slot 10 for wrench bodies 7, 8. Support slot 10 is equipped in FIG. 1 on the upper part with a clamping part 9 that overlaps the latter, and clamping part 9 is fastened with pins 6, 6′ to handle parts 2, 3 and is equipped with a fluting 9′. In FIG. 3, the upper ends of handle parts 2, 3 are designed nose-shaped as clamping part 9 and are equipped with fluting 11. Handle parts 2, 3 are equipped with recesses 17 as accommodation for swivel axis 21 and recess 29 for holding pin 30 for spring 28.

Handle 1 in FIG. 4 consists of a part with nozzles 1a, 1b that are made nose-shaped at the ends between which a slot 31 is designed. Nozzles 1a, 1b are equipped with a curved recess 32 that has varying diameters for the accommodation of swivel axis 21 of wrench body 8. For adjustment and holding of wrench body 8, swivel axis 21 is equipped with a spring 26 and with annular parts 22 on its ends. Wrench body 8 is equipped in bearing flange 23 with a recess 34 for swivel axis 21 and is loaded by a spring 35 that is attached in slot 31 of the handle and is held in a recess 36 of bearing flange 23.

Wrench body 7 in FIG. 1 and FIG. 2 consists of a head part and clamping part 7′, which is equipped with a reinforcement piece 16 with clamping surfaces 14, 15 with fluting, a bearing flange 23 which is equipped with a support slot 20 with a varying internal diameter 18, 19 for swivel axis 21.

The wrench body of FIG. 3 consists of a head part 8 with clamping surfaces 13, 14, 15, and a bearing flange 23 which is equipped with a support slot 20 with varying internal diameters 18, 19 for swivel axis 21. Wrench bodies 7, 8 are accommodated in support slot 20 of handle 1 at swivel axis 21, in such a way that the swivel axis is made to swivel around the handle ends and can be adjusted in gripping opening 12 by swivel axis 21 in support slot 20 of wrench body 7, 8 that has varying internal diameters 18, 19. Spring elements 26, 28, 35, which are actively connected to handle 1 and wrench bodies 7, 8, hold wrench bodies 7, 8 against the parts that are being gripped in such a way that ratchet movements are possible.

Swivel axis 21 of FIG. 1, FIG. 2 and FIG. 3, has a reinforced part 24 in the center and is accommodated in recesses 17 of handle parts 2, 3 and can be moved against the pressure of spring 25, which is arranged on swivel axis 21 between handle part 3 and annular part 22.

On one end, handle 1 in FIG. 5 has a thicker part 1c with clamping part 10 and a recess 37 on both sides for the accommodation of wrench body 8 as well as a recess 38 for swivel axis 21. Wrench body 8 has the thickness of part 1c of handle 1 and is equipped at its lower part with a recess 40 for handle part 37 as well as a recess 41 for swivel axis 21, which is connected tightly with wrench body 8.

To keep wrench body 8 against clamping part 11 of handle 1, a spring 26 is arranged on swivel axis 39 whose leg 26′ has supported it in recess 40 of wrench body 8 and is fastened there.

With these universal wrenches, parts and connecting elements of various sizes and shapes can be gripped regardless of whether these are accessible axially or radially.

It is also possible to adjust the wrench body as required in the gripping opening and the gripping angle to be able to better grip the parts and connecting elements and to keep them against it.

The novelty is not limited to the depicted handle and wrench body shapes or the type and arrangement of the spring elements, since also other shapes and arrangements are provided.

1. Universal wrench with at least one open wrench body, which is designed and fastened on the end of a handle or on a device that is made on the end of the handle for snug holding of a part that is to be gripped or a connecting element in such a way that the wrench body is held against the part that is being gripped or the connecting element and can be pivoted and adjusted in its gripping plane relative to the handle, characterized in that wrench body (7, 8) can pivot on its bearing flange (23) on a swivel axis (21) that is movably fastened to handle (1) and can be adjusted in its gripping plane (12) and with its clamping surfaces (13, 14, 15) can be engaged with clamping surfaces (9, 10) of handle (1).

2. Universal wrench according to claim 1, wherein wrench body (7, 8) is equipped with reinforcement piece (16) and a bearing flange (23) with a support slot (20) with varying diameters (18, 19) for swivel axis (21).

3. Universal wrench according to claim 1, wherein clamping bodies (7, 8) are loaded by a spring (26, 28, 35) that is connected with handle (1) or swivel axis (21) and are equipped with a recess 40.

4. Universal wrench according to one of claims 1 to 3, wherein swivel axis (21) has a reinforcement piece (24) and is arranged to move in recesses (17, 32) of handle (1) and is equipped with annular parts (22) and a spring (25), which is fastened between handle parts (2, 3) and annular part (22).

5. Universal wrench according to one of claims 1 to 4, wherein handle (1) consists of handle parts (2, 3), which are connected with one another with pins (4, 5, 6) and are designed nose-shaped on their ends and are equipped with clamping parts (9, 10) with fluting (11).

6. Universal wrench according to claim 5, wherein handle parts (2, 3) are equipped with offsets (2′, 3′), which form a support slot (10) for wrench bodies (7, 8).

7. Universal wrench according to claims 5 and 6, wherein handle parts (2, 3) are equipped with a recess (17) for the accommodation of swivel axis (21).

8. Universal wrench according to claim 1, wherein handle (1) consists of a part and is equipped on the ends with nose-shaped nozzles (1a, 1b) between which a slot (31) for wrench bodies (7, 8) is made.

9. Universal wrench according to one of claims 1 to 8, wherein nozzles (1a, 1b) of handle (1) are equipped with a recess (32) that has varying diameters (18, 19, 20) for swivel axis (21) that is mounted to be able to move therein.

10. Universal wrench according to one of claims 1 to 9, wherein wrench bodies (7, 8) are arranged on both ends of handle (1).

11. Universal wrench according to one of claims 1 to 10 wherein handle (1) is equipped with a thicker part (1c) with recesses (37) on both sides.
